(19) United States
(12) Patent Application Publication
(10) Pub. No.: US 2026/0171813 A1
(43) Pub. Date: Jun. 18, 2026

(54) MOBILE ENERGY MANAGEMENT SYSTEM AND METHODS THEREOF

(71) Applicant: Saudi Electricity Company, Riyadh (SA)

(72) Inventors: Majed Mohammed M. ALSAQRI, Jeddah (SA); Saleh Ali G. SHANNAN, Jeddah (SA); Murad Mebaireik A. ALMAZROUI, Jeddah (SA); Rami Saleh M. ALBATATI, Jeddah (SA)

(21) Appl. No.: 19/383,178

(22) Filed: Nov. 7, 2025

(30) Foreign Application Priority Data
Nov. 10, 2024 (SA) 1020246623

(51) Int. Cl. H02J 7/50; B62B 3/10; H02J 7/00; H02J 7/80

(52) U.S. Cl. CPC H02J 7/50; B62B 3/10; H02J 7/80; H02J 7/865; B62B 2202/61

(57) ABSTRACT

The present invention relates to a mobile energy management system and a method for its operation. The system comprises a mobile generator configured to generate electrical power, a charging interface unit electrically connected to the mobile generator and configured to convert the electrical power therefrom, and a mobile battery unit configured to receive electrical power from the charging interface unit and store electrical energy. The mobile battery unit is configured to operate independently from the mobile generator and the charging interface unit to provide electrical power. The method primarily involves providing power by leaving the mobile battery unit on-site for power supply, then using the mobile generator as a mobile charger to recharge this unit when needed. This enables the system to efficiently and sequentially service multiple consumer locations, particularly during emergency situations.

### FIELD OF THE INVENTION

The present invention relates to systems and methods for energy management using mobile emergency generators. More specifically, the invention relates to transferring electrical energy generated from mobile emergency generators to mobile battery units, and subsequently utilizing the stored energy to supply electrical power to consumers' premises during power outages.

### BACKGROUND OF THE INVENTION

Traditional emergency power supply systems rely on generators being directly connected to consumers' electrical meters during power outages. In such conventional systems, the generator must remain in continuous operation to maintain power supply, regardless of the actual electrical load demand from the consumer. This approach results in several disadvantages including high fuel consumption, excessive noise, environmental pollution, and inefficient generator utilization.

When a mobile generator operates at low loads for extended periods, it experiences mechanical stress and reduced operational efficiency. The generator may operate at percentages lower than factory-recommended levels, leading to increased maintenance requirements and potential equipment failures. Additionally, the continuous operation of generators results in unnecessary fuel consumption when consumer electrical loads are minimal.

Prior art systems have attempted to address energy storage and conversion challenges. For example, US Patent Application Publication No. US20180312072A1 discloses an electrical energy conversion system with components within a vehicle, including charging and discharging devices and battery storage. However, such prior art systems operate as integrated blocks with permanently connected components, limiting maintenance flexibility and requiring complete system dismantling for repairs.

Furthermore, existing systems may require the energy storage unit to remain connected to the charging source and necessitate multiple charging units for fleet operations. These limitations prevent optimal generator utilization and fail to address the specific challenges of mobile emergency power generation for utility consumers.

There exists a need for an improved system and method that enables mobile generators to function as portable charging units for battery storage systems, allowing generators to operate at optimal efficiency for shorter periods while providing continuous power supply through stored energy.

### SUMMARY OF THE INVENTION

The present invention provides a system and method for transferring and storing energy from mobile generators (e.g. an emergency mobile generator) to mobile battery units (e.g. an emergency mobile battery unit), and subsequently reusing the stored energy at customer/consumers' premises, for example, for providing emergency electricity due to a power shortage. The system addresses the inefficiencies of traditional mobile generator operations by enabling generators to function as mobile charging units rather than continuous power sources.

In one aspect, the invention comprises a mobile energy management system including a mobile generator configured to generate electrical power, a charging interface unit electrically connected to the mobile generator and configured to convert electrical power from the mobile generator, and a mobile battery unit configured to receive electrical power from the charging interface unit and store electrical energy, wherein the mobile battery unit is configured to operate independently from the mobile generator and charging interface unit to provide electrical power. The system may be configured to operate in multiple modes, including a normal operation mode where pre-charged battery cells supply power to consumers, and a charging mode where the mobile generator charges the mobile battery unit.

The mobile battery unit may comprise battery cells configured to store electrical energy, control units configured to monitor and manage charging and discharging operations, and an AC inverter adapter configured to convert stored electrical energy from DC to AC. The mobile battery unit and charging interface unit may be connected by means of output cables and entry ports. The charging interface unit and mobile generator may be connected by means of feeder ports and input cable terminals, wherein the charging interface unit is connected to a distribution panel comprised within the mobile generator.

The mobile battery unit may comprise connection plugs for electrically connecting the mobile battery unit to an electrical meter to provide electrical power to the electrical meter. The system may further comprise a trolley configured to facilitate transportation and positioning of the mobile battery unit at consumer locations to provide electrical power.

The mobile battery unit may comprise a plurality of separable modules. The plurality of separable modules may comprise a first section comprising a battery charging module for charging operations, a second section comprising a battery discharging module for discharge operations, a third section comprising a control circuit module, a fourth section comprising a DC to AC inverter module, and a fifth section comprising an interconnection module configured to provide electrical pathways between the different modules of the mobile battery unit. The separable modules may be connected through fastening gears that enable separation and reconnection of individual modules.

The control units may be configured to monitor battery charge levels and generate alerts when battery charge levels fall below a predetermined threshold. The predetermined threshold may be approximately 20% of full charge capacity. The charging interface unit may be configured to convert AC electrical power from the mobile generator to DC electrical power for charging the mobile battery unit, and the mobile battery unit may comprise an AC inverter adapter configured to convert stored DC electrical energy back to AC electrical power. The system may further comprise a cable reel mounted on the mobile battery unit for cable management.

In another aspect, the invention provides a method for providing electrical power comprising positioning a mobile battery unit at a location requiring electrical power, wherein the location comprises an electrical meter, connecting the mobile battery unit to the electrical meter, supplying electrical power from the mobile battery unit to the electrical meter, monitoring charge levels of the mobile battery unit, when charge levels fall below a predetermined threshold, dispatching a mobile generator to the location, connecting the mobile generator to the mobile battery unit through a charging interface unit, and charging the mobile battery unit.

The method may further comprise disconnecting the mobile generator from the mobile battery unit after charging is complete and dispatching the mobile generator to charge additional mobile battery units at other consumer locations. The predetermined threshold may be approximately 20% of full charge capacity. Connecting the mobile generator to the mobile battery unit through a charging interface unit may comprise connecting input cable terminals of the charging interface unit to feeder ports of the mobile generator, and connecting output cables of the charging interface unit to entry ports of the mobile battery unit. The mobile battery unit may simultaneously receive charging current and supply power to the electrical meter during the charging process.

In an embodiment, the method comprises the step of removing the mobile generator (1) from the location while the mobile battery unit (3) continues to provide electrical power. In another embodiment, the method comprises the step of transporting the mobile generator (1) to a different location while the mobile battery unit (3) remains connected to the consumer electrical system. The mobile battery unit (3) may be operated at a first location while simultaneously operating the mobile generator (1) at a second location. Power supply may be maintained to the consumer through the mobile battery unit (3) in the absence of the mobile generator (1). In an embodiment, the charging interface unit (2) travels with the mobile generator (1) and is absent from the consumer location during normal battery operation.

The invention may include use of a mobile energy management system for providing emergency electrical power during utility outages. A method of transferring and storing energy from a mobile generator to a mobile battery unit may comprise transporting a mobile battery unit to a location requiring electrical power, wherein the location comprises an electrical meter, connecting input cable terminals of a charging interface unit to feeder ports of a distribution panel of a mobile generator, connecting output cables from the charging interface unit to entry ports of the mobile battery unit, connecting connection plugs from the mobile battery unit to the electrical meter, operating the mobile generator to initiate an electrical charger containing AC to DC voltage conversion circuitry for transferring AC to DC current to battery cells, and simultaneously passing electric current from the battery cells to an AC inverter adapter to convert DC power current to AC current and then to the electrical meter, wherein the mobile battery unit is configured to operate independently from the mobile generator and charging interface unit to provide electrical power. For example, the mobile battery unit (3) can provide electrical power without being connected to the mobile generator (1).

After charging completion, the method may further comprise stopping the mobile generator, disconnecting the input cable terminals of the charging interface unit from the feeder ports of the distribution panel, disconnecting the output cables of the charging interface unit from the entry ports of the mobile battery unit, disconnecting a trolley from the mobile generator by disconnecting a coupling mechanism, and dispatching the mobile generator to provide service at another location. The mobile generator may have a capacity of up to 1500 kW (e.g. from 100 kW to 1500 kW) for accelerating electric charging through the charging interface unit.

In an embodiment, the mobile generator (1) may be configured with variable power output capabilities ranging from 100 kW to 1500 kW to accommodate different charging requirements and customer load demands. The charging interface unit (2) may include intelligent load management circuitry that automatically adjusts charging parameters based on battery condition, ambient temperature, and available generator capacity. The system may monitor real-time power consumption at consumer locations and adjust battery discharge rates to optimize energy utilization.

A method of sequential charging may comprise receiving notifications from one or more mobile battery units when charge levels are low, mapping a path for a mobile generator based on the notifications to provide service to the one or more mobile battery units, determining location and charge level data to improve efficiency of the path and service time, sequentially charging multiple mobile battery units at different customer locations using a single mobile generator and charging interface unit, disconnecting the mobile generator from each mobile battery unit after charging completion, and maximizing operational return of the mobile generator by increasing the number of units that can be charged within a predetermined time period. The sequential charging may achieve complete separation between generation function and storage and feeding function at service locations. The sequential charging may reduce operating time and number of mobile emergency generators used in multi-charge operations during emergency situations.

The method may include operating the mobile generator at optimal load conditions for efficient charging, disconnecting the generator after charging completion, and enabling the generator to service multiple mobile battery units at different consumer locations. This approach may reduce fuel consumption, minimize noise pollution, and improve generator operational efficiency.

The system may enable separation of system components for distributed service provision, allowing multiple service providers to operate different system elements. The modular design may facilitate maintenance operations and system scalability. For example, the modular design of the mobile battery unit (3) may enable field reconfiguration by adding or removing individual sections based on specific customer power requirements. Additional battery modules may be connected in parallel to increase storage capacity, while inverter modules may be configured in series or parallel arrangements to provide different voltage and current outputs. The interconnection module (26) may include standardized connection interfaces that enable rapid assembly and disassembly of system components.

The present invention relates to systems and methods for energy management using mobile emergency generators. The invention provides a system for transferring electrical energy generated from mobile emergency generators to mobile battery units, and subsequently utilizing the stored energy to supply electrical power to consumers' premises during power outages. The system comprises a mobile generator, a charging interface unit, a mobile battery unit with multiple separable modules, and connection components for interfacing with consumer electrical meters. The system operates in multiple modes including normal operation where pre-charged battery cells supply power to consumers, and charging mode where the mobile generator charges the mobile battery unit. The method includes positioning a mobile battery unit at a consumer location, monitoring battery charge levels, and dispatching a mobile generator to recharge the mobile battery unit when battery levels decrease below predetermined thresholds. This approach reduces fuel consumption, minimizes noise pollution, and improves generator operational efficiency by enabling generators to operate at optimal load conditions for shorter periods while providing continuous power supply through stored energy.

### BRIEF DESCRIPTION OF THE DRAWINGS

FIG. 1 illustrates a side perspective view of a mobile energy management system showing the mobile generator (1), charging interface unit (2), mobile battery unit (3) mounted on trolley (4), and associated components including hinges (5), cable reel (6), and coupling mechanism (7).

FIG. 2 shows a service sequence provided by the system, illustrating the electrical connections and energy flow from the distribution panel (8) through feeder ports (9), input cable terminals (10), output cables (11), entry ports (12), battery cells (13), control units (14, 15), AC inverter adapter (16), connection plugs (17), to the electrical meter (18).

FIG. 3 depicts an outside perspective view of the mobile battery unit (3) displaying the modular construction with separable components including first section (19), second section (22), third section (23), fourth section (24), fifth section (25), fastening gears (20), interconnection module (26), and connection points (27).

### DETAILED DESCRIPTION

Mobile Generator—As used herein, the term “mobile generator” refers to a portable electrical power generation unit mounted on a wheeled platform or vehicle chassis, capable of being transported between different locations and configured to generate electrical power using fuel sources such as diesel, biofuels, natural gas, or other combustible materials.

Charging Interface Unit—As used herein, the term “charging interface unit” refers to an electrical conversion device that receives AC electrical power from a mobile generator and converts it to appropriate charging parameters for battery storage systems, including voltage regulation, current control, and power conditioning functions.

Mobile Battery Unit—As used herein, the term “mobile battery unit” refers to a portable energy storage system comprising battery cells, power conversion circuitry, and control systems, configured to store electrical energy and convert stored energy for output to consumer electrical systems.

Separable Modules—As used herein, the term “separable modules” refers to individual components or sections that can be mechanically disconnected from each other for maintenance, repair, or reconfiguration purposes while maintaining electrical and mechanical interfaces for reconnection.

Fastening Gears—As used herein, the term “fastening gears” refers to mechanical connection mechanisms that enable the secure attachment and detachment of modular components, including overlapping mounting structures, latching systems, or interlocking mechanisms.

Sequential Charging—As used herein, the term “sequential charging” refers to a method of operating a single mobile generator to charge multiple mobile battery units at different locations in succession, rather than simultaneously.

Independent Operation—As used herein, the term “independent operation” refers to the capability of the mobile battery unit to provide electrical power to consumer systems without requiring physical connection to or presence of the mobile generator.

Predetermined Threshold—As used herein, the term “predetermined threshold” refers to a battery charge level, typically expressed as a percentage of full capacity, below which charging operations are initiated.

The present invention relates to an integrated system and method for the transmission and storage of electrical energy in emergency situations for customers of utility companies. The system may comprise an integrated configuration starting from a mobile emergency generator with capacities of up to 1500 kW, a high-speed electric charger, and mobile battery units positioned on a dedicated transfer cart, connected to a flexible cable reel to provide delivery service to the customer's electrical meter.

The method may rely on the installation of mobile battery units at customers affected by power outages, where the units are connected to electrical meter outlets to supply stored energy. The battery charge level may be monitored automatically through a control system, and when the charge level becomes low, the mobile generator may be directed to the customer's location to connect with the fast charger and initiate the charging process.

The method may be characterized by the capability to disconnect the generator from the battery cart after charging completion and direct it to charge other mobile battery units at different customer locations, or to refuel. The system and method together may achieve rapid electric charging and fuel savings, while enhancing safety requirements through eliminating the need to store fuel at customer sites, reducing noise pollution, and increasing customer service efficiency through the ability to serve multiple customers with a single generator.

The system and method may be suitable for serving electricity customers during periods of service interruption with direct connection to meters, temporary construction project meters, event and venue site meters, and remote areas distant from the electrical grid.

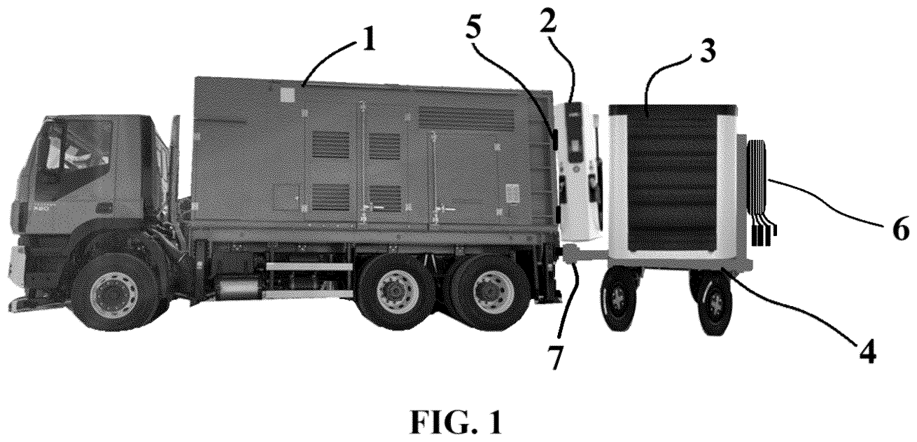

Referring to FIG. 1, the system comprises a plurality of interconnected components that can be connected and disconnected as needed, designed to provide efficient energy transfer and storage services. The mobile generator (1) serves as the primary energy source, utilizing biofuels or other suitable fuels (e.g. diesel fuel) to generate electrical power. The mobile generator (1) is mounted on a multi-axle truck platform providing mobility for the entire system. The charging interface unit (2) converts the generator's AC output to appropriate charging parameters for the battery storage system and includes hinges (5) that facilitate positioning and deployment of the unit.

The mobile battery unit (3) represents a central component of the system, housing battery cells and power conversion circuitry. The unit is mounted on a trolley (4) to facilitate transportation and positioning at consumer locations. The trolley (4) includes wheels to enable easy movement of the mobile battery unit and can be connected to or disconnected from the mobile generator (1) via coupling mechanism (7). A cable reel (6) mounted on the mobile battery unit (3) provides cable management and storage capabilities for connection plugs (17). The cable reel (6) may accommodate cables of varying lengths from 10 to 100 meters, enabling flexible positioning of the mobile generator relative to consumer electrical meters while maintaining secure electrical connections.

The charging interface unit (2) includes hinges (5) that control movement and positioning, allowing for easy deployment when needed. Connection plugs (17) interface the system with consumer electrical meters (18) to provide integrated power supply services. The arrangement of components allows the system to function as an integrated mobile power generation and storage unit, with the capability to separate the mobile battery unit (3) and trolley (4) from the generator (1) for distributed service provision.

The system may operate according to multiple operational modes, each designed to optimize energy efficiency and service delivery. The mobile energy management system comprises a mobile generator configured to generate electrical power, a charging interface unit electrically connected to the mobile generator and configured to convert electrical power from the mobile generator, and a mobile battery unit configured to receive electrical power from the charging interface unit and store electrical energy, wherein the mobile battery unit is configured to operate independently from the mobile generator and charging interface unit to provide electrical power.

When the battery charge level decreases below a predetermined threshold, the control units (14, 15) within the mobile battery unit (3) may transmit an alert signal to notify service personnel. The control units (14, 15) may incorporate advanced wireless communication capabilities including cellular, Wi-Fi, or satellite communication modules to enable real-time monitoring and remote management of battery status across multiple deployment locations. The wireless communication system may transmit battery charge levels, operational status, maintenance alerts, and location data to a central monitoring station. The system may utilize GPS tracking to provide precise location information for route optimization and service dispatch coordination. The control units are configured to monitor battery charge levels and generate alerts when battery charge levels fall below a predetermined threshold, which may be approximately 20% of full charge capacity.

Upon receiving the alert notification, a mobile generator (1) equipped with the charging interface unit (2) may be dispatched to the consumer location. Service technicians may connect the output cables (11) from the charging interface unit (2) to the entry ports (12) of the mobile battery unit (3). The charging process may commence automatically once proper connections are established, with the charging interface unit (2) converting the generator's AC output to appropriate DC charging parameters for the battery storage system. The charging interface unit is configured to convert AC electrical power from the mobile generator to DC electrical power for charging the mobile battery unit, and the mobile battery unit comprises an AC inverter adapter configured to convert stored DC electrical energy back to AC electrical power.

The charging operation may continue until the battery cells (13) reach full capacity, with the control units (14, 15) monitoring the charging progress and automatically terminating the process upon completion. During the charging cycle, the system may maintain continuous power supply to the consumer through the AC inverter adapter (16), ensuring uninterrupted service throughout the charging period. The mobile battery unit simultaneously receives charging current and supplies power to the electrical meter during the charging process.

Following completion of the charging process, the service technician may disconnect the charging cables and prepare the mobile generator (1) for transport to the next service location. The mobile generator (1) may then proceed to service additional mobile battery units at other consumer locations, utilizing the same connection and charging methodology to provide distributed emergency power services across multiple sites.

The mobile battery unit (3) may operate in a standalone mode where it provides continuous electrical power to consumer premises while physically separated from the mobile generator (1) and/or the charging interface unit (2). During normal operation, the mobile battery unit (3) remains positioned at the consumer location while the mobile generator (1) is absent from the site, enabling the generator to service other locations or return to a central depot for refueling and maintenance. This physical separation between power generation and power delivery components allows a single mobile generator (1) to support multiple mobile battery units (3) deployed across different consumer locations simultaneously.

The system may be configured such that the mobile battery unit (3) provides uninterrupted power supply for extended periods without requiring the presence of the mobile generator (1) at the service location. The mobile generator (1) may be dispatched to the consumer location only when charging is required, after which it may be immediately removed and relocated to service additional battery units at other sites. This operational methodology enables the mobile generator (1) to maximize its utilization by serving multiple customers in sequence rather than remaining idle at a single location during periods of low power demand.

The mobile battery unit (3) may include location tracking and communication systems that enable remote monitoring of its operational status while the mobile generator (1) operates independently at different geographic locations. The system architecture facilitates complete operational independence between the mobile generator (1) and mobile battery unit (3), with the generator functioning as a mobile charging service that visits battery units on demand rather than maintaining permanent physical connection or proximity to the storage units during power delivery operations.

The mobile generator (1) and mobile battery unit (3) may be configured for independent transportation to different locations. The mobile generator (1) can be relocated while the mobile battery unit (3) remains at a consumer location to provide electrical power.

In normal operation mode, the mobile battery unit is typically fully charged when service initiation occurs. A technician may position the trolley (4) at the consumer location and disconnect it from the generator using coupling mechanism (7). The trolley (4) may be positioned adjacent to the consumer's electrical meter (18). The system further comprises a trolley configured to facilitate transportation and positioning of the mobile battery unit at consumer locations to provide electrical power.

The technician may connect connection plugs (17) from the cable reel (6) mounted on the mobile battery unit (3) to electrical meter (18) according to predetermined connection sequences. The main breaker of the meter may be activated to commence power supply service. During this mode, the generator (1) may be available to service other consumer locations. The mobile battery unit comprises connection plugs for electrically connecting the mobile battery unit to an electrical meter to provide electrical power to the electrical meter. The system further comprises a cable reel mounted on the mobile battery unit for cable management.

When the battery charge level decreases to a predetermined threshold, such as 20%, control units (14, 15) within the mobile battery unit (3) may generate alerts to notify service technicians. The control unit (14) includes wireless communication capability to transmit these alerts. The system may then transition to charging mode operation.

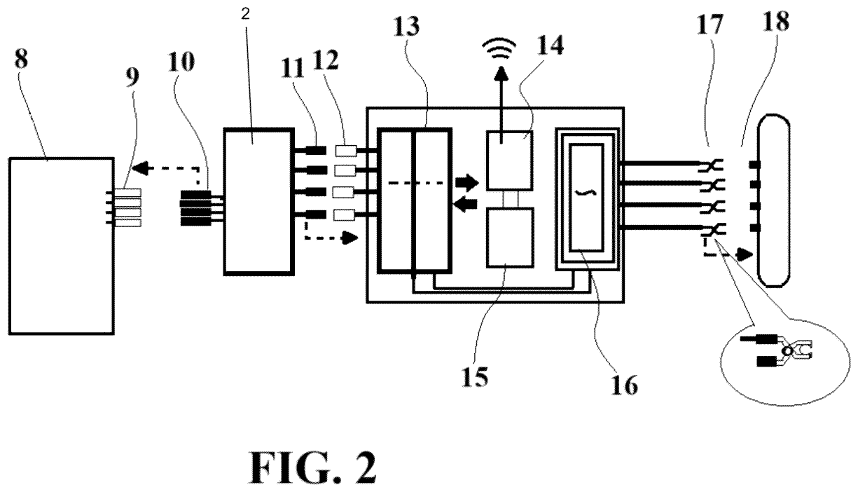

Referring to FIG. 2, when the mobile generator (1) arrives at the consumer location, the technician may connect input cable terminals (10) of the charging interface unit (2) to feeder ports (9) of the distribution panel (8). Output cables (11) of the charging interface unit (2) may be connected to entry ports (12) of the mobile battery unit (3). The mobile battery unit and charging interface unit are connected by means of output cables and entry ports. The charging interface unit and mobile generator are connected by means of feeder ports and input cable terminals, wherein the charging interface unit is connected to a distribution panel comprised within the mobile generator.

Upon activation of the generator and charging initiation, the electrical charger may commence operation. The charger may include AC to DC voltage conversion circuitry to provide appropriate charging current to battery cells (13). The control units (14, 15) monitor and manage the charging and discharging operations. Simultaneously, electrical current may flow from the battery cells (13) through the AC inverter adapter (16) to convert DC current to AC current for transmission through connection plugs (17) to the consumer electrical meter (18). The mobile battery unit comprises battery cells configured to store electrical energy, control units configured to monitor and manage charging and discharging operations, and an AC inverter adapter configured to convert stored electrical energy from DC to AC.

This configuration may enable continuous power supply to the consumer while the battery cells (13) are being recharged, ensuring uninterrupted service during the charging process. The service sequence illustrates how electrical energy flows from the distribution panel (8) through the charging components and into the mobile battery unit via entry ports (12).

Upon completion of the charging process, the technician may stop generator operation and disconnect the circuit breaker. Input cable terminals (10) of the charging interface unit (2) may be disconnected from feeder ports (9) in the distribution panel (8). Output cables (11) of the charging interface unit (2) may be disconnected from entry ports (12) of the mobile battery unit (3).

Following service completion, connection plugs (17) remain connected to the electrical meter (18) and cables are returned to normal storage positions on the cable reel (6) mounted on the mobile battery unit (3). The technician may reconnect the trolley (4) to the generator (1) through coupling mechanism (7) and transport the system back to a service center for inspection and preparation for subsequent service calls.

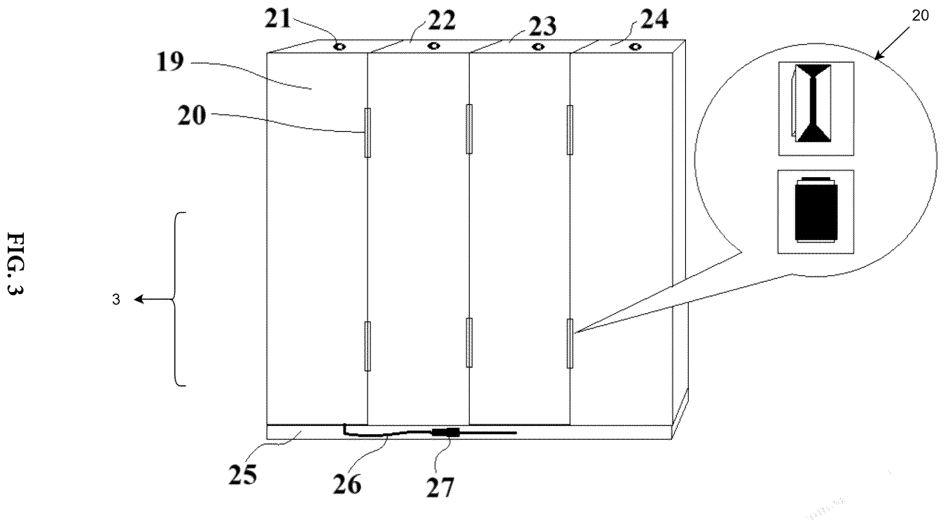

Referring to FIG. 3, the mobile battery unit (3) may comprise multiple separable modules connected through fastening gears (20). Individual modules may be separated by lifting from the top (21) and reconnected by lowering modules into position using overlapping mounting gear mechanisms provided by the fastening gears (20). The mobile battery unit comprises a plurality of separable modules. The separable modules are connected through fastening gears that enable separation and reconnection of individual modules. The separable modules may be configured in various combinations, with individual modules containing single or multiple functional components. The overlapping mounting gears may comprise interlocking mechanical interfaces that align and secure adjacent modules through complementary engagement surfaces.

The mobile battery unit may contain multiple separable sections for maintenance purposes:

The first section (19) may house battery cells equipped for charging operations. The second section (22) may contain battery cells equipped for discharge operations. The third section (23) may house control unit circuitry. The fourth section (24) may contain DC to AC inverter components. The fifth section (25) positioned at the bottom may house interconnection module (26) that provides electrical pathways between the different modules of the system. The plurality of separable modules comprise a first section comprising a battery charging module for charging operations, a second section comprising a battery discharging module for discharge operations, a third section comprising a control circuit module, a fourth section comprising a DC to AC inverter module, and a fifth section comprising an interconnection module configured to provide electrical pathways between the different modules of the mobile battery unit.

During maintenance operations, technicians may remove front covers and manually separate components by disconnecting connection points (27) of elements requiring maintenance. The connection points (27) establish electrical connections between the various components and can be manually disconnected to isolate individual boxes for service or replacement. This modular design may facilitate independent maintenance of system components without requiring complete system disassembly.

The modular mobile battery unit may comprise a plurality of separable modules connected through fastening gears. The unit may include at least one module containing battery cells configured for charging operations, at least one module containing battery cells configured for discharge operations, at least one module containing control units, at least one module containing an AC inverter adapter, and at least one module containing an interconnection module.

Individual modules may be separated for independent maintenance by lifting from the top. The fastening gears may comprise overlapping mounting gears that facilitate the connection and disconnection of modules. The mobile battery unit may further comprise connection points that can be manually disconnected during maintenance operations, allowing technicians to isolate specific modules for service or replacement.

The mobile battery unit may be mounted on a trolley for transportation between consumer locations, enabling the unit to be easily moved and positioned at different service sites. The control units may be configured to monitor battery charge levels and generate alerts when charge levels fall below predetermined thresholds, providing automated notification to service personnel when charging is required.

The described system may provide several operational advantages over conventional mobile generator systems. Generator utilization may be optimized by operating at higher load percentages for shorter durations, potentially reducing mechanical stress and maintenance requirements. Fuel consumption may be reduced by eliminating continuous generator operation during low-demand periods.

The system may enable a single generator to service multiple consumer locations by charging multiple mobile battery units in sequence. This approach may reduce the total number of generators required for emergency power services and may decrease operational costs.

Environmental benefits may include reduced noise pollution and emissions due to decreased generator operating time. The modular system design may enable distributed service provision, allowing multiple service providers to operate different system components and potentially improving service quality and availability.

In one embodiment, the system may comprise system elements used to provide a service of transferring and converting electrical energy generated from mobile emergency generators using biofuels to mobile battery units, then benefiting from using them according to consumer needs instead of depending on permanent mobile generator operation without considering loads consumed by consumers in all circumstances and situations.

The system elements may comprise a start and an end, with the start being from the mobile generator (1) and the end being the connection points in the electrical meter (18). The system may consist of main parts including the mobile generator (1), a charging interface unit (2), a mobile battery unit (3), a trolley (4) for driving the unit, a cable reel (6) mounted on the mobile battery unit (3) and connection plugs (17) that connect the system to the consumer electrical meter (18) to provide integrated service.

The charging interface unit may have hinges (5) controlling movement to facilitate deployment when needed.

In another embodiment, a method for connecting the system in normal mode may involve fully charged system battery cells when service initiates. A specialized technician may stop the trolley (4) and unplug it by disconnecting coupling mechanism (7) from the generator and placing the trolley next to the service meter. The technician may connect connection plugs (17) from the cable reel (6) mounted on the mobile battery unit (3) at feeding terminals to the electrical meter (18) according to recommended sequences without turning on the generator and initiate connection of the main meter breaker to start providing service. The generator in this mode may service meters in other locations, and when electric charge level reduces to 20%, the control unit (14) in the mobile battery unit (3) may send alerts to specialized technicians, who may go to the location and connect the system in charging mode according to recommended methods.

In a further embodiment, a method for connecting the system in charging mode may involve the technician connecting input cable terminals (10) of the charging interface unit (2) to feeder ports (9) of the distribution panel (8), wherein the distribution panel (8) is part of the mobile generator (1) and serves as the generator's electrical output distribution system. The technician may then connect output cables (11) of the charging interface unit in entry ports (12) of the mobile battery unit (3). The technician may initiate generator operation and press the charging button. The electrical charger may initiate operation, containing an AC voltage to DC voltage converter, and current may be transferred to battery cells (13). Simultaneously, electric current may continue to pass from battery cells to the AC inverter adapter (16) to convert electric current from DC to AC current and transfer it through connection plugs (17) to feed terminals in the electrical meter (18).

In another embodiment, a method for unplugging the system when charging is complete may involve the technician stopping generator operation and unplugging the circuit breaker. Input cable terminals (10) of the charging interface unit (2) may be unplugged from feeder ports (9) in the distribution panel (8), then output cables (11) of the charging interface unit may be unplugged from entry ports (12) of the mobile battery unit (3), and connection plugs (17) may remain connected to feed terminals in the electrical meter (18) with cables returned to the cable reel (6) mounted on the mobile battery unit (3). After completing electrical service to the consumer, the technician may connect the trolley (4) to the generator through coupling mechanism (7) and drive it back to the initiation center to inspect and recharge it to provide service again to consumers.

In yet another embodiment, a method for unplugging the mobile battery unit in the system for maintenance purposes may involve the mobile battery unit (3) comprising one or more sections, wherein the sections can be connected to each other through fastening gears (20). The sections may be separated when lifted from the top (21) and connected to each other by lowering the section in a process depending on a latch having overlapping mounting gears. The unit has five sections as follows:
First Section (19)—Battery charging module equipped for charging operations;
Second Section (22)—Battery discharge module equipped for discharge operations;
Third Section (23)—Control circuit module;
Fourth Section (24)—DC to AC inverter module;
Fifth Section (25)—interconnection module (26) positioned at the bottom of the mobile battery unit (3) and serves as the foundation module that provides electrical pathways between the different modules of the system, where specialists can remove the front cover and separate it manually during maintenance by removing connection points (27) of the section to be maintained.

### Methods and System Configurations

In an embodiment, a method of transferring and storing energy from mobile emergency generators whose capacities can be changed according to the need to mobile batteries may include the following operational steps: Transferring the electrical energy conversion and storage unit (also referred to as mobile battery unit throughout the application) to a customer's location by relying on the trolley or by means of the mobile generator, and connecting it mechanically with the mobile generator. The method may start by stopping the generator at the emergency location and the technician connecting the input cable terminals to the charging interface unit in the feeder ports to the distribution panel and then connecting the output cables from the charging interface unit to the entry ports to the electrical energy conversion and storage unit, then connecting the connection plugs from the cable reel mounted on the mobile battery unit to the customer's electrical meter and then turning on the generator and allowing the electrical charger to run, which basically contains AC to DC voltage conversion circuitry for AC to DC current transfer to battery cells. At the same moment, the electric current may continue to pass from the battery cells to the AC inverter adapter to convert the DC power current to AC current and then to the customer's electrical meter.

After the charging process is completed, the mobile generator may be disconnected by the following steps: The technician turns the generator off and then disconnects the input cable terminals of the charging interface unit from the feeder ports of the distribution panel and then disconnects the output cables of the charging interface unit from the entry ports of the electrical energy conversion and storage unit while the connection plugs remain connected to the electrical meter. The technician may disconnect the trolley from the generator by disconnecting the coupling mechanism from the generator and returning the cables to the cable reel mounted on the mobile battery unit and then the generator goes to provide service in another location. This sequential method may achieve a complete separation between the generation function and the storage and feeding function at service, which enables the service of several customers with a single generator and charging interface unit and reduces the operating time and number of mobile emergency generators used in the multi-charge operation in emergency situations. The sequential charging method may utilize automated notification systems that transmit battery status, location coordinates, and urgency levels to a central dispatch system. The path mapping algorithm may calculate optimal routes considering travel time, fuel consumption, and service priority levels.

The system may include a centralized fleet management platform that receives notifications from multiple mobile battery units simultaneously and automatically calculates optimal service routes for mobile generators. The route optimization algorithm may consider factors including battery charge levels, geographic proximity, traffic conditions, and generator fuel levels to maximize operational efficiency. The system may prioritize service calls based on critical infrastructure needs, customer service agreements, and remaining battery capacity at each location

In another embodiment, the mobile generator may be replaced as needed with a capacity that complies with the requirements of fast charging with operating capacities of up to 1500 kW during the process of converting and storing energy. Choosing a generator with high capacities may accelerate electric charging through the charging interface unit when the voltage is chosen directly with the control of the current rise from the mobile generator, the required charge is achieved, which is raised when a high-capacity mobile generator and high-speed charging interface unit are provided, so that this feature may reduce the charging time and ensure faster and more reliable service. The mobile generator has a capacity of up to 1500 kW for accelerating electric charging through the charging interface unit.

In a further embodiment, the path of the mobile generator may be mapped based on the notifications received from the electrical energy conversion and storage units when the charge level is low to provide service to different customers. This feature may determine the location and charge level data to improve the efficiency of the path and service time, which increases the number of units that can be charged within a certain period of time and maximizes the operational return of the generator. A method of sequential charging comprises receiving notifications from one or more mobile battery units when charge levels are low, mapping a path for a mobile generator based on the notifications to provide service to the one or more mobile battery units, determining location and charge level data to improve efficiency of the path and service time, sequentially charging multiple mobile battery units at different customer locations using a single mobile generator and charging interface unit, disconnecting the mobile generator from each mobile battery unit after charging completion, and maximizing operational return of the mobile generator by increasing the number of units that can be charged within a predetermined time period.

In another embodiment, a method to accelerate electric charging and energy storage from mobile emergency generators to mobile batteries may be achieved by controlling the increase in the voltage of the mobile generator as well as the current intensity to reach a shorter period of time for charging. This method may achieve the optimal use of the maximum energy from the mobile generator, especially in capacities exceeding 1000 kW.

In yet another embodiment, a system for transferring and storing energy from mobile emergency generators to mobile batteries and reconnecting them in electrical meters may include the mobile generator with a capacity of up to 1500 kW, and a charging interface unit electrically connected to the mobile generator by connecting the input cable terminals to feeder ports, electrical energy conversion and storage unit located on a trolley to drive the unit, and connection plugs from the cable reel mounted on the mobile battery unit to connect with the electrical meter. This integrated structural configuration may work to provide a fast and flexible service to cover emergency electrical outages, as this can be achieved by controlling the increase voltage of the mobile generator as well as the current intensity to reach the appropriate time period for charging.

In an embodiment, the system may contain a cable reel mounted on the mobile battery unit with multiple lengths that can reach the subscribers' meters with ease, through which the appropriate place for the vehicle to be parked during the provision of the service can be determined and in accordance with the subscribers' positions.

In one embodiment, a method of transferring and storing energy from mobile emergency generators whose capacities can be changed according to the need to mobile battery units may include the following operational steps: Transferring the electric energy conversion and storage unit to a customer's location self-charging by relying on a special transmission unit or by means of the mobile generator, and connecting it mechanically with the mobile generator, where the method starts by stopping the generator at the emergency location and the technician connects the ends of the input cables to the fast charger Ultra-Fast Charger in the Feed Ports Power Outlets to the Distribution Panel and then connect the Output Cables from the fast charger to the Input Ports to the Power Conversion and Storage Unit then connect the feed terminals to the Customer's Energy Meter and then turn on the generator and allow the electric charger to run Charger, which basically contains a Rectifier/AC-DC Inverter for AC to DC and DC Current Transfer to Batteries, at the same moment the electric current continues to pass from the batteries to the AC Inverter DC-AC Inverter to convert the DC power current to AC backcurrent And then to the Customer's Energy Meter Feeders.

After the charging process is completed, the mobile generator may be disconnected by the following steps: The technician turns the generator off and then disconnects the ends of the output cables of the fast charger from the power outlets of the distribution panel and then the disconnection of the output cables of the fast charger from the input ports of the power conversion and storage unit and then the connection plugs are disconnected. From the feeding ends of the counter, the technician disconnects the cart from the generator by unconnecting the Towing Coupler/Hitch from the generator and returning the cables to the flexible cable wheel Cable Reel and then the generator goes to provide service in another location, as this sequential method achieves a complete separation between the generation function and the storage and feeding function at service, which enables the service of several customers with a single generator and a fast service charger and reduces the operating time. The total and number of mobile emergency generators used in the multi-charge operation in emergency situations.

In another embodiment, a method of transferring and storing energy from mobile emergency generators to mobile batteries may include the mobile generator being replaced as needed with a capacity that complies with the requirements of fast charging with operating capacities of up to 1500 kW during the process of converting and storing energy, where choosing a generator with high capacities accelerates electric charging through an ultra-fast charger When the voltage is chosen directly with the control of the current rise from the mobile generator, the required charge is achieved, which is raised when a high-capacity mobile generator and a high-speed electric charger are provided, so that this feature reduces the charging time and ensures faster and more reliable service.

In a further embodiment, a method of transferring and storing energy from mobile emergency generators to mobile batteries may include the path of the Mobile Generator being mapped based on the notifications received from the conversion and storage units when the charge level is low to provide service to different customers, as this feature determines the location and charge level data to improve the efficiency of the path and service time, which increases the number of units that can be charged within a certain period of time and maximizes the operational return of the generator.

In yet another embodiment, the method of disconnecting the Power Conversion and Storage Unit for the purpose of maintenance may include the charging unit consisting of 5 boxes according to the following:
Box I—Batteries area for charging. Charging Batteries Compartment
Box II—The area of the batteries intended for discharge. Discharging Batteries Compartment
Box III—Console area. Control Unit Compartment
Box IV—DC to AC inverter area. DC-AC Inverter Compartment
Fifth Lower Box—Wiring Loom Compartment Area Wiring Loom Compartment The specialist can remove the front cover and disconnect it manually by removing the connection terminals of the item to be maintained.

These boxes, which are mechanically connected to each other, can be separated by movable racks for fixing and can be detached when the handle of the element is lifted from the top by means of an independent lifting tool.

In another embodiment, a method to accelerate electric charging and energy storage from mobile emergency generators to mobile batteries may be achieved by controlling the increase in the voltage of the mobile generator as well as the current intensity to reach a shorter period of time for charging, as this method achieves the optimal use of the maximum energy from the mobile generator, especially in capacities exceeding 1000 kW.

In a further embodiment, a system for transferring and storing energy from mobile emergency generators to mobile batteries and reconnecting them in electricity meters may include the electric charging speed being increased through the use of Mobile Generator with a capacity of 1500 kW, and an Ultra-Fast Charger Electrically connected to the mobile generator by connecting the ends of input cables and power outlets Power Outlets, Electrical Energy Conversion and Storage Unit The Power Conversion and Storage Unit is located inside a box that runs on a chassis/trailer cart to drive the unit, and quick disconnect connections to connect with the power meter feed circuit, as this integrated structural configuration works to provide a fast and flexible service to cover emergency electrical outages, as this can be achieved by controlling the increase voltage of the mobile generator as well as the current intensity to reach the appropriate time period for charging.

In yet another embodiment, a system for transferring and storing energy from mobile emergency generators to mobile batteries and reconnecting them in electricity meters may contain a flexible cable wheel with multiple lengths that can reach the subscribers' meters with ease, through which the appropriate place for the vehicle to be parked during the provision of the service can be determined and in accordance with the subscribers' positions.

1. A mobile energy management system comprising:
a mobile generator configured to generate electrical power;
a charging interface unit electrically connected to the mobile generator and configured to convert electrical power from the mobile generator; and
a mobile battery unit configured to receive electrical power from the charging interface unit and store electrical energy, wherein the mobile battery unit is configured to operate independently from the mobile generator to provide electrical power.

2. The system of claim 1, wherein the mobile battery unit comprises:
battery cells configured to store electrical energy;
a control unit configured to monitor and manage charging and discharging operations; and
an AC inverter adapter configured to convert stored electrical energy from DC to AC.

3. The system of claim 1, wherein the mobile battery unit and charging interface unit are connected by means of output cables and entry ports.

4. The system of claim 1, wherein the charging interface unit and mobile generator are connected by means of feeder ports and input cable terminals, wherein the charging interface unit is connected to a distribution panel comprised within the mobile generator.

5. The system of claim 1, wherein the mobile battery unit comprises connection plugs for electrically connecting the mobile battery unit to an electrical meter to provide electrical power to the electrical meter.

6. The system of claim 1, further comprising a trolley configured to facilitate transportation and positioning of the mobile battery unit at consumer locations to provide electrical power.

7. The system of claim 1, wherein the mobile battery unit comprises a plurality of separable modules.

8. The system of claim 7, wherein the plurality of separable modules comprise:
a first section comprising a battery charging module for charging operations;
a second section comprising a battery discharging module for discharge operations;
a third section comprising a control circuit module;
a fourth section comprising a DC to AC inverter module; and
a fifth section comprising an interconnection module configured to provide electrical pathways between the different modules of the mobile battery unit.

9. The system of claim 7, wherein the separable modules are connected through fastening gears that enable separation and reconnection of individual modules.

10. The system of claim 2, wherein the control unit is configured to monitor battery charge levels and generate alerts when battery charge levels fall below a predetermined threshold.

11. The system of claim 10, wherein the predetermined threshold is approximately 20% of full charge capacity.

12. The system of claim 1, wherein the charging interface unit is configured to convert AC electrical power from the mobile generator to DC electrical power for charging the mobile battery unit, and the mobile battery unit comprises an AC inverter adapter configured to convert stored DC electrical energy back to AC electrical power.

13. The system of claim 1, further comprising a cable reel mounted on the mobile battery unit for cable management.

14. A method for providing electrical power comprising:
positioning a mobile battery unit at a location requiring electrical power, wherein the location comprises an electrical meter;
connecting the mobile battery unit to the electrical meter;
supplying electrical power from the mobile battery unit to the electrical meter;
monitoring charge levels of the mobile battery unit;
when charge levels fall below a predetermined threshold, dispatching a mobile generator to the location;
connecting the mobile generator to the mobile battery unit through a charging interface unit; and
charging the mobile battery unit.

15. The method of claim 14, further comprising disconnecting the mobile generator from the mobile battery unit after charging is complete and dispatching the mobile generator to charge additional mobile battery units at other consumer locations.

16. The method of claim 14, wherein the predetermined threshold is approximately 20% of full charge capacity.

17. The method of claim 14, wherein connecting the mobile generator to the mobile battery unit through a charging interface unit comprises:
connecting input cable terminals of the charging interface unit to feeder ports of the mobile generator; and
connecting output cables of the charging interface unit to entry ports of the mobile battery unit.

18. The method of claim 14, wherein the mobile battery unit simultaneously receives charging current and supplies power to the electrical meter during the charging process.

19. Use of a mobile energy management system for providing emergency electrical power during a power outage.

20. A method of transferring and storing energy from a mobile generator to a mobile battery unit comprising:
transporting a mobile battery unit to a location requiring electrical power, wherein the location comprises an electrical meter;
connecting input cable terminals of a charging interface unit to feeder ports of a distribution panel of a mobile generator;
connecting output cables from the charging interface unit to entry ports of the mobile battery unit;
connecting connection plugs from the mobile battery unit to the electrical meter;
operating the mobile generator to initiate an electrical charger containing AC to DC voltage conversion circuitry for transferring AC to DC current to battery cells; and
simultaneously passing electric current from the battery cells to an AC inverter adapter to convert DC power current to AC current and then to the electrical meter,
wherein the mobile battery unit is configured to operate independently from the mobile generator and charging interface unit to provide electrical power.

21. The method of claim 20, further comprising after charging completion:
stopping the mobile generator; and/or
disconnecting the input cable terminals of the charging interface unit from the feeder ports of the distribution panel; and/or
disconnecting the output cables of the charging interface unit from the entry ports of the mobile battery unit; and/or
disconnecting a trolley from the mobile generator by disconnecting a coupling mechanism; and/or
dispatching the mobile generator to provide service at another location.

22. The method of claim 20, wherein the mobile generator has a capacity of up to 1500 kW for accelerating electric charging through the charging interface unit.

23. A method of sequential charging comprising:
receiving notifications from one or more mobile battery units when charge levels are low;
mapping a path for a mobile generator based on the notifications to provide service to the one or more mobile battery units;
determining location and charge level data to improve efficiency of the path and service time;
sequentially charging multiple mobile battery units at different customer locations using a single mobile generator and charging interface unit;
disconnecting the mobile generator from each mobile battery unit after charging completion.

24. The method of claim 23, wherein the sequential charging achieves complete separation between generation function and storage and feeding function at service locations.

25. The method of claim 23, wherein the sequential charging reduces operating time and number of mobile emergency generators used in multi-charge operations during emergency situations.
